(19) United States
(12) Patent Application Publication
(10) Pub. No.: US 2019/0084131 A1
(43) Pub. Date: Mar. 21, 2019

(54) TRANSMISSION ELEMENT

(71) Applicant: Jen-Yung YANG, Taichung City (TW)

(72) Inventor: Jen-Yung YANG, Taichung City (TW)

(21) Appl. No.: 15/832,670

(22) Filed: Dec. 5, 2017

(30) Foreign Application Priority Data
Sep. 15, 2017 (TW) 106213765

(51) Int. Cl. B25B 13/48; B25B 23/00

(52) U.S. Cl. CPC B25B 13/481; B25B 23/0021

(57) ABSTRACT

In a transmission element provided in the present invention, a connecting piece is used as a center, a first end piece and a second end piece are separately disposed at two ends of the connecting piece, and the second end piece and the connecting piece are at least pivotally joined, to make relative positions between a first acting portion located on the first end piece and a second acting portion located on the second end piece change with pivotal movement of the second end piece relative to the connecting piece, so as to further adjust an overall shape of the transmission element to adapt the transmission element for being joined to a working object in a narrow space, thereby providing work content that an operator uses another tool to perform a transmission operation by using the transmission element.

### BACKGROUND OF THE INVENTION

### 1. Field of the Invention

The present invention relates to tools, and in particular, to a transmission element.

### 2. Description of the Related Art

An operating space is limited during work in an operating environment of a narrow space. As a result, when a tool needs to be used, work fails to be done because the tool cannot enter the narrow space or the tool enters the narrow space yet cannot be properly joined to a working object.

### SUMMARY OF THE INVENTION

Therefore, a main objective of the present invention is to provide a transmission element whose shape can be changed to adapt to changing operating environments, so that the transmission element can be joined to a working object in a limited operating space, thereby facilitating work by an operator.

In view of this, to achieve the foregoing objective, in a transmission element provided in the present invention, a connecting piece is used as a center, a first end piece and a second end piece are separately disposed at two ends of the connecting piece, and the second end piece and the connecting piece are at least pivotally joined, to make relative positions between a first acting portion located on the first end piece and a second acting portion located on the second end piece change with pivotal movement of the second end piece relative to the connecting piece, so as to further adjust an overall shape of the transmission element to adapt the transmission element for being joined to a working object in a narrow space, thereby providing work content that an operator uses another tool to perform a transmission operation by using the transmission element.

The second end piece has a second end body, an end of the second end body being pivotally disposed at the other end, far away from the first end piece, of the connecting piece by using a first shaft, and the second end body being rotatable between a normal position and a pivoted position about the first shaft as a rotation axis, and the second acting portion, located at the other end, far away from the connecting piece, of the second end body, and making a distance between the second acting portion and the first acting portion change with pivotal movement of the second end body, where the distance between the second acting portion and the first acting portion when the second end body is located at the normal position is less than the distance between the second acting portion and the first acting portion when the second end body is located at the pivoted position.

An end of a first end body is pivotally connected to an end of the connecting piece by using a second shaft, the first end body is rotatable between a normal position and a pivoted position, and the distance between the second acting portion and the first acting portion when the first end body is located at the normal position is less than the distance between the second acting portion and the first acting portion when the first end body is located at the pivoted position.

To enable the first end body or the second end body to be positioned at the normal position, an elastic force is used to elastically keep the first end body or the second end body at the normal position. To achieve this, the transmission element further includes a first elastic portion, disposed between the second end body and the connecting piece, to provide an elastic pushing force, so as to enable the second end body to be elastically located at the normal position. Correspondingly, a second elastic portion is disposed between the first end body and the connecting piece, to provide an elastic pushing force, to enable the first end body to be elastically located at the normal position.

### BRIEF DESCRIPTION OF THE DRAWINGS

FIG. 1 is a three-dimensional diagram of a preferred embodiment of the present invention.

FIG. 2 is an exploded diagram of a preferred embodiment of the present invention.

FIG. 3 is a planar diagram of a preferred embodiment of the present invention.

FIG. 4 is a partial sectional diagram according to a preferred embodiment of the present invention, where the first end body and the second end body are located at the normal position.

FIG. 5 is a partial sectional diagram according to a preferred embodiment of the present invention, where the first end body and the second end body are located at the pivoted position.

FIG. 6 is a schematic use diagram according to a preferred embodiment of the present invention, where the first end body and the second end body are located at the pivoted position.

FIG. 7 is a schematic use diagram according to a preferred embodiment of the present invention, where the first end body and the second end body are located at the normal position.

### DETAILED DESCRIPTION OF THE PREFERRED EMBODIMENTS

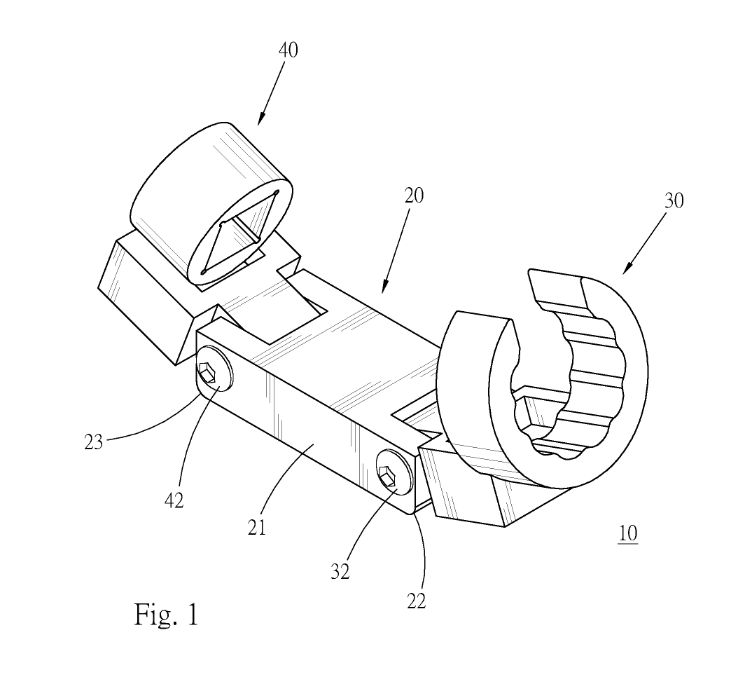

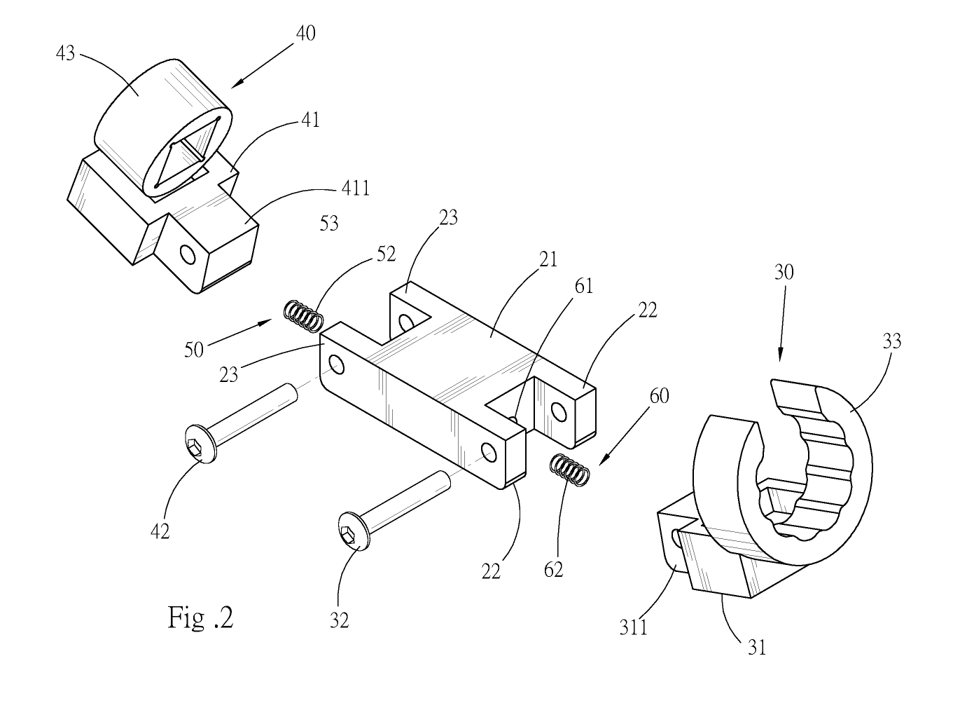

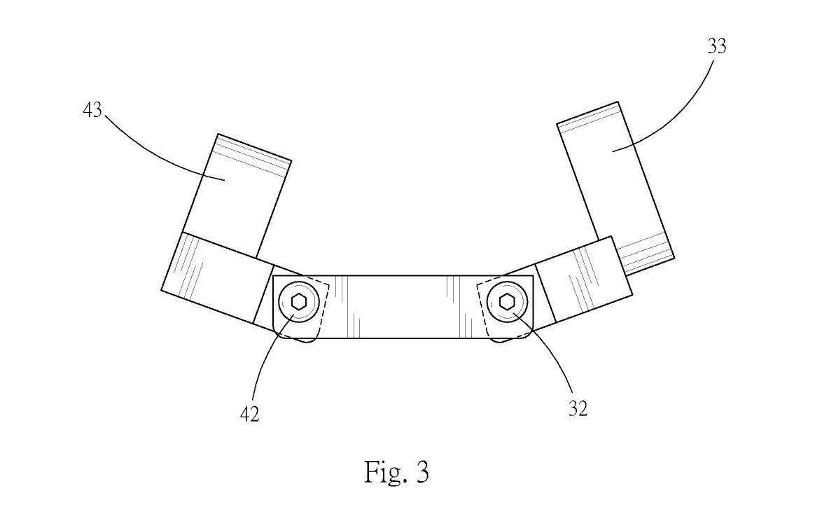

Referring to FIG. 1 to FIG. 3, a transmission element (10) provided in a preferred embodiment of the present invent ion mainly includes a connecting piece (20), a first end piece (30), a second end piece (40), a first elastic portion (50), and a second elastic portion (60).

The connecting piece (20) is a rectangular connecting block (21). A pair of first connecting pivoting lugs (22) and a pair of second connecting pivoting lugs (23) are protrudingly disposed on end surfaces at two ends of a long axis of the connecting block (21) separately.

The first end piece (30) is a block-shaped first end body (31). A pivotal end (311) at an end of the first end piece (30) is inserted between the pair of first connecting pivoting lugs (22). A first shaft (32) is bridged between the pair of first connecting pivoting lugs (22) and passes through the pivotal end (311) of the first end body (31). In this way, the first end body (31) rotates about the first shaft (32) as a rotation axis. An arc-form first acting portion (33) having a C shape is adjacently and fixedly disposed on a side at the other end of the first end body (31) by using a closed end of the C shape.

The second end piece (40) and the first end piece (30) are symmetrically disposed on the connecting piece (20). A pivotal end (411) at an end of a block-shaped second end body (41) is inserted between the pair of second connecting pivoting lugs (23). A second shaft (42) is bridged between the pair of second connecting pivoting lugs (23) and passes through the pivotal end (411) of the second end body (41). In this way, the second end body (41) rotates about the second shaft (42) as a shaft. A side of an annular second acting portion (43) is radially attached to and fixedly disposed on a side at the other end of the second end body (41).

The first elastic portion (50) has a first blind hole (51), is concavely disposed at an end of the long axis of the connecting block (21), and is located between the pair of second connecting pivoting lugs (23). A hole opening is located next to an axial side of the second shaft (42), and is towards a surface of the pivotal end (411) of the second end body (41). A first elastic body (52) such as a spring is received in the first blind hole (51). An end of the first elastic body (52) is held against a hole bottom wall of the first blind hole (51), and the other end of the first elastic body (52) protrudes from the hole opening of the first blind hole (51) and is held against the surface of the pivotal end (411) of the second end body (41).

The structure of the second elastic portion (60) is similar to that of the first elastic portion (50), so that an elastic pushing force may be provided to the first end body (31). The second elastic portion (60) has a second blind hole (61), is concavely disposed at the other end of the long axis of the connecting block (21), and is located between the pair of first connecting pivoting lugs (22). A hole opening is located next to an axial side of the first shaft (32), and is towards a surface of the pivotal end (311) of the first end body (31). A second elastic body (62) such as a spring is received in the second blind hole (61). An end of the second elastic body (62) is held against a hole bottom wall of the second blind hole (61), and the other end of the second elastic body (62) protrudes from the hole opening of the second blind hole (61) and is held against the surface of the pivotal end (311) of the first end body (31).

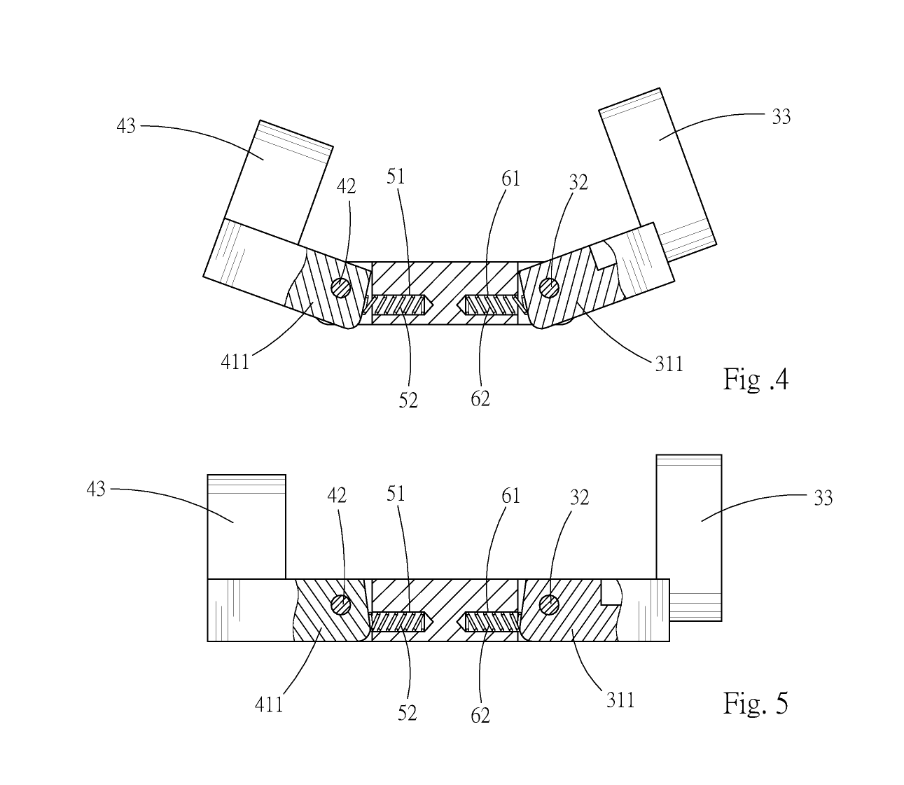

By means of the formation of the foregoing member, the first end body (31) and the second end body (41) may respectively rotate between a normal position and a pivoted position individually. A distance between the first acting portion (33) and the second acting portion (43) is relatively short when the first acting portion (33) and the second acting portion (43) are at the normal position as shown in FIG. 4 and is relatively long when the first acting portion (33) and the second acting portion (43) are located at the pivoted position as shown in FIG. 5.

The first elastic portion (50) and the second elastic portion (60) may be used to respectively provide an elastic force to the second end body (41) and the first end body (31), to elastically keep the second end body (41) and the first end body (31) at the normal position respectively.

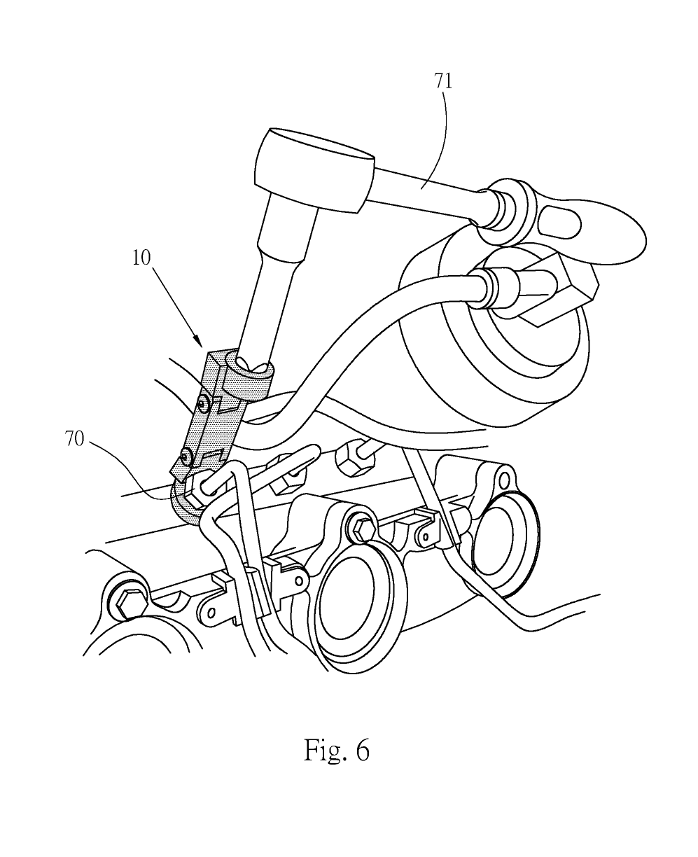

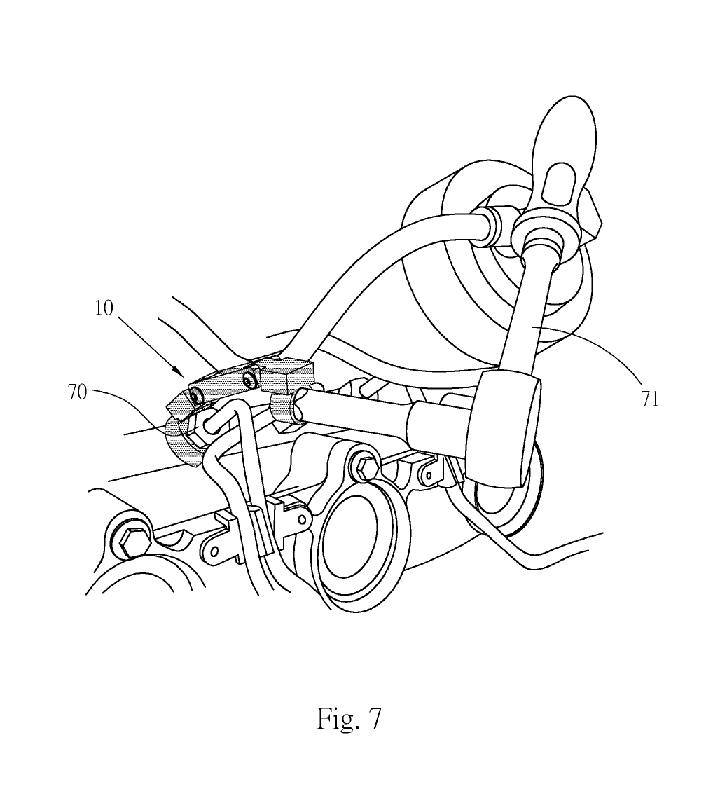

In this way, during the use of the transmission element (10), the shape of the transmission element (10) can be changed to adapt to an actual operating space, so that the first acting portion (33) is fastened to an object to be processed. Specifically, as shown in FIG. 6 and FIG. 7, the transmission element (10) is inserted in a fixed element (70) of an oil supply pipe of a vehicle engine, and an external tool such as a wrench (71) is connected to the second acting portion (43). In this manner, a force is transmitted via the transmission element (10) to an object to be processed to ensure successful work.

What is claimed is:

1. A transmission element, comprising:
a connecting piece;
a first end piece, having a first end body, an end of the first end body being disposed at an end of the connecting piece, and a first acting portion, being located at the other end, far away from the connecting piece, of the first end body; and
a second end piece, having a second end body, an end of the second end body being pivotally disposed at the other end, far away from the first end piece, of the connecting piece by using a first shaft, and the second end body being rotatable between a normal position and a pivoted position about the first shaft as a rotation axis, and a second acting portion, located at the other end, far away from the connecting piece, of the second end body, and making a distance between the second acting portion and the first acting portion change with pivotal movement of the second end body, wherein the distance between the second acting portion and the first acting portion when the second end body is located at the normal position is less than the distance between the second acting portion and the first acting portion when the second end body is located at the pivoted position;
a first elastic portion, disposed between the second end body and the connecting piece, to provide an elastic pushing force, so as to enable the second end body to be elastically located at the normal position.

2. The transmission element according to claim 1, wherein the end of the first end body is pivotally connected to the end of the connecting piece by using a second shaft, and the first end body is rotatable between a normal position and a pivoted position, and the distance between the second acting portion and the first acting portion when the first end body is located at the normal position is less than the distance between the second acting portion and the first acting portion when the first end body is located at the pivoted position.

3. The transmission element according to claim 2, further comprising a second elastic portion, disposed between the first end body and the connecting piece, to provide an elastic pushing force, to enable the first end body to be elastically located at the normal position.

4. The transmission element according to claim 1, wherein the first elastic portion has a first blind hole, disposed at an end of the connecting piece, a first elastic body is received in the first blind hole, and an end of the first elastic body is held against the second end body.

5. The transmission element according to claim 2, wherein the first elastic portion has a first blind hole, disposed at an end of the connecting piece, a first elastic body is received in the first blind hole, and an end of the first elastic body is held against the second end body.

6. The transmission element according to claim 3, wherein the first elastic portion has a first blind hole, disposed at an end of the connecting piece, a first elastic body is received in the first blind hole, and an end of the first elastic body is held against the second end body.

7. The transmission element according to claim 4, wherein the first elastic body abuts a side, eccentric towards the first shaft, of the second end body.

8. The transmission element according to claim 5, wherein the first elastic body abuts a side, eccentric towards the first shaft, of the second end body.

9. The transmission element according to claim 6, wherein the first elastic body abuts a side, eccentric towards the first shaft, of the second end body.

10. The transmission element according to claim 3, wherein the second elastic portion has a second blind hole and is disposed at the other end of the connecting piece, a second elastic body is received in the second blind hole, and an end of the second elastic body is held against the first end body.

11. The transmission element according to claim 10, wherein the second elastic body abuts a side, eccentric towards the second shaft, of the first end body.

12. The transmission element according to claim 1, wherein the first acting portion has a C shape, and the second acting portion is annular.

13. The transmission element according to claim 2, wherein the first acting portion has a C shape, and the second acting portion is annular.

14. The transmission element according to claim 3, wherein the first acting portion has a C shape, and the second acting portion is annular.
